(19) United States
(12) Patent Application Publication
(10) Pub. No.: US 2015/0357638 A1
(43) Pub. Date: Dec. 10, 2015

(54) CATHODE ACTIVE MATERIAL FOR LITHIUM SECONDARY BATTERY, METHOD FOR MANUFACTURING THE SAME, AND LITHIUM SECONDARY BATTERY USING THE SAME

(71) Applicants: IUCF-HYU(INDUSTRY-UNIVERSITY COOPERATION FOUNDATION HANYANG UNIVERSITY), Seongdong-gu Seoul (KR); ENERCERAMIC INC., Dongdaemun-gu Seoul (KR)

(72) Inventors: Yang Kook SUN, Seoul (KR); Hyung Joo NOH, Bucheon-si, Gyeonggi-do (KR); Sang Hyuk LEE, Busan (KR)

(21) Appl. No.: 14/762,156

(22) PCT Filed: Feb. 3, 2014
(86) PCT No.: PCT/KR2014/000925

§ 371 Date: Jul. 20, 2015

(30) Foreign Application Priority Data
Jan. 31, 2013 (KR) 10-2013-0011138
Feb. 3, 2014 (KR) 10-2014-0012313

(51) Int. Cl. H01M 4/36; H01M 4/04; H01M 10/0525; H01M 4/525; H01M 4/505

(52) U.S. Cl. CPC H01M 4/366; H01M 4/525; H01M 4/505; H01M 10/0525; H01M 4/0402; H01M 2220/20; H01M 2220/30

(57) ABSTRACT

The present invention provides a cathode active material on which at least one coating layer is formed, a method for manufacturing the same, and a lithium secondary battery including the same. According to the present invention, since the coating layer with high electrical conductivity is formed on a surface of the cathode active material, the electrical conductivity is improved to enhance charge/discharge and cycle life characteristics and thermal stability of the battery.

### TECHNICAL FIELD

The present invention relates to a cathode active material for a lithium secondary battery, a method for manufacturing the same, and a lithium secondary battery using the same. More particularly, the present invention relates to a cathode active material capable of improving cycle life and charge/discharge characteristics of a lithium secondary battery by means of at least one coating layer formed on a surface of the cathode active material, a method for manufacturing the same, and a lithium secondary battery using the same.

### BACKGROUND ART

Recently, portable electronic products such as a camcorder, a portable phone and a notebook personal computer have been generally used with the rapid development of electronic, communication and computer industries, so light, long-lifetime and high-reliable batteries have been demanded. In particular, a lithium secondary battery has an operating voltage of 3.7V or more, so an energy density per a unit weight of the lithium secondary battery is higher than those of a nickel-cadmium battery and a nickel-hydrogen battery. Thus, the lithium secondary battery has been increasingly demanded as a power source for driving the portable electronic, information and communication devices.

Recently, in U.S.A., Japan, and Europe, researches have been actively conducted for a power source of a hybrid electric car which can be formed by hybridizing an internal-combustion engine and the lithium secondary battery. A plug-in hybrid electric vehicle (P-HEV) battery used in a car traveling 60 miles or less a day has been actively developed primarily in U.S.A. The P-HEV battery has characteristics closer to those of an electric car, so it is required to develop a high-capacity battery. In particular, it may be required to develop a cathode material having a tap density of 2.0 g/cc or more and a high-capacity of 230 mAh/g or more.

LiCoO₂, LiNiO₂, LiMnO₂, LiMn₂O₄, and LiFePO₄ correspond to cathode materials which are commercialized or still under development. Among them, LiCoO₂ is an excellent material having a stable charge/discharge characteristic, excellent electronic conductivity, a high battery voltage, high stability, and an even discharge voltage characteristic. However, since little Co is deposited and Co is expensive and poisonous to a human body, it is required to develop a now cathode material. In addition, a crystal structure of Co is unstable in charging by delithiation, so a thermal characteristic of Co is very poor.

To solve these, a transition metal element may be substituted for a portion of nickel to move a heat-generating start temperature to a high-temperature, or a heat-generating peak may become broad to prevent a sharp increase in temperature. However, the expected results have failed to come.

In other words, LiNi₁₋ₓCoₓO₂ (x=0.1-0.3) obtained by substituting cobalt for the portion of nickel has excellent charge/discharge and cycle life characteristics but does not have thermal stability. In addition, European Patent No. 0872450 discloses LiₐCo_{b}Mn_{c}M_{d}Ni_{1-(b+c+d)}O₂ (M=B, Al, Si. Fe, Cr, Cu, Zn, W, Ti, Ga) obtained by substituting Co, Mn and another nickel for nickel. However, the thermal stability problem of a Ni-based material does not solved.

To solve this problem, Korean patent publication No. 10-2005-0083869 discloses a lithium transition metal oxide in which a metal composition has a concentration gradient. According to this method, an internal material having a constant composition is synthesized, and a material having a different composition is coated on the internal material to manufacture a double layer. Thereafter, the double layer is mixed with lithium salt, and the mixture is thermally treated. A lithium transition metal oxide may be used as the internal material. However, a metal composition of a cathode active material is discontinuously changed between the internal material and external material which are generated, so an internal structure is unstable.

In addition, Korean Patent Registration No. 10-0693822 discloses a cathode active material having a substituted result concentration gradient. According to this, a concentration gradient is formed at an interface region of a core and a coating layer by coating or substitution to improve quality of a surface. However, the concentration gradient is not formed on the whole.

### DISCLOSURE OF THE INVENTION

### Technical Problem

The present invention provides a cathode active material having a new structure including at least one coating on a surface, a method for manufacturing the same, and a lithium secondary battery including the same.

### Technical Solution

Embodiments of the present invention provide a cathode active material for a lithium secondary battery.

At least one coating layer is formed on a surface of the cathode active material.

The cathode active material includes: a core portion represented by the following chemical formula 1; and

a surface portion represented by the following chemical formula 2.

Liₐ₁M1ₓ₁M2_{y1}M3_{z1}M4_{w}O_{2+δ} [Chemical formula 1]

Liₐ₂M1ₓ₂M2_{y2}M3_{z2}M4_{w}O_{2+δ} [Chemical formula 2]

In the chemical formulas 1 and 2, “M1”, “M2”, and “M3” are selected from the group consisting of Ni, Co, Mn, and any combination thereof, “M4” is selected from the group consisting of Fe, Na, Mg, Ca, Ti, V, Cr, Cu, Zn, Ge, Sr, Ag, Ba, Zr, Nb, Mo, Al, Ga, B, and any combination thereof, 0<a1≦1.1, 0<a2≦1.1, 0≦x1≦1, 0≦x2≦1, 0≦y1≦1, 0≦y2≦1, 0≦z1≦1, 0≦z2≦1, 0≦w≦0.1, 0.0≦δ≦0 0.5, 0<x1+y1+z1≦1, 0<x2+y2+z2≦1, y1≦y2, and z2≦z1.

In an embodiment of the present invention, the coating layer may include at least one element selected from a group consisting of P, Zr, Sc, Y, Li, Na, K, Rb, Mg, Ca, Sr, Ba, La, Ti, V, Nb, Cr, Mo, W, Mn, Re, Fe, Ru, Os, Co, Rh, Ir, Ni, Pd, Pt, Cu, Ag, Au, Zn, B, Al, Ga, In, Si, Ge, Sn, Pb, As, Sb, Bi, Se, Te, and any combination thereof.

In an embodiment of the present invention, the coating layer may be represented by the following chemical formula 3.

DₚJ_{q}Oᵣ [Chemical formula 3]

In the chemical formula 3, “D” is selected from a group consisting of P, Zr, Sc, Y, Li, Na, K, Rb, Mg, Ca, Sr, Ba, La, Ti, V, Nb, Cr, Mo, W, Mn, Re, Fe, Ru, Os, Co, Rh, Ir, Ni, Pd, Pt, Cu, Ag, Au, Zn, B, Al, Ga, In, Si, Ge, Sn, Pb, As, Sb, Bi, Se, Te, and any combination thereof.

In the chemical formula 3, “J” is selected from a group consisting of Li, Na, K, Rb, Mg, Ca, Sr, Ba, Y, La, Ti, Zr, V, Nb, Cr, Mo, W, Mn, Re, Fe, Ru, Os, Co, Rh, Ir, Ni, Pd, Pt, Cu, Ag, Au, Zn, B, Al, Ga, In, Si, Ge, Sn, Pb, As, Sb, Bi, Se, Te, and any combination thereof, 0<p≦4, 0≦q≦1, and 0<r≦10.

In an embodiment of the present invention, the coating layer may be selected from a group consisting of ZrO₂, PO₄, SeO₃, and SnO₂. Since the cathode active material according to an embodiment of the present invention includes the coating layer selected from a group consisting of ZrO₂, PO₄, SeO₃, and SnO₂, stability and conductivity of the cathode active material may be improved together.

In an embodiment of the present invention, the coating layer may be single-layered or multi-layered and may have an island shape. If the coating layer has a layered shape, the coating layer can be uniformly coated. If the coating layer has the island shape, the coating layer may selectively react with a specific active point of the surface of the active material. Thus, side reaction can be controlled and electrical characteristics and thermal stability can be improved.

Electrochemical characteristics of the cathode active material of the present invention may be varied depending on a content of the coating layer. If a coating material is added, a coating element may be physically or chemically combined with the inside of a particle or between particles. Thus, when particles are firstly formed during a subsequent thermal treatment (e.g., in an air atmosphere), particles may be prevented from being bonded to each other and growth of the particles may be inhibited.

In an embodiment of the present invention, a thickness of the coating layer may be in a range of 1 nm to 150 nm.

In an embodiment of the present invention, the cathode active material for the lithium secondary battery including the core portion represented by the chemical formula 1 and the surface portion represented by the chemical formula 2 may be prepared in the following manner:

A thickness of the core portion may be in a range of 10% to 70% of a total size of a particle of the cathode active material for the lithium secondary battery, and

a concentration of metal ions from the core portion to the surface portion may be uniformly represented by the chemical formula 2.

In an embodiment of the present invention, the cathode active material for the lithium secondary battery including the core portion represented by the chemical formula 1 and the surface portion represented by the chemical formula 2 may be prepared in the following manner:

A thickness of the core portion is in a range of 10% to 70% of a total size of a particle of the cathode active material for the lithium secondary battery,

a thickness of the surface portion is in a range of 1% to 5% of the total size of the particle of the cathode active material for the lithium secondary battery, and

concentrations of M1, M2, and M3 have continuous concentration gradients from the core portion to the surface portion.

In an embodiment of the present invention, the cathode active material for the lithium secondary battery including the core portion represented by the chemical formula 1 and the surface portion represented by the chemical formula 2 may be prepared in the following manner:

A thickness of the core portion and a thickness of the surface portion range from 1% to 5% of a total size of a particle of the cathode active material for the lithium secondary battery, and

concentrations of M1, M2, and M3 have continuous concentration gradients from the core portion to the surface portion.

In an embodiment of the present invention, the cathode active material for the lithium secondary battery including the core portion represented by the chemical formula 1 and the surface portion represented by the chemical formula 2 may be prepared in the following manner:

The concentrations of M1 and M2 have continuously increasing concentration gradients from the core portion to the surface portion, and the concentration of M3 has continuously decreasing concentration gradient from the core portion to the surface portion.

In an embodiment of the present invention, the cathode active material for the lithium secondary battery including the core portion represented by the chemical formula 1 and the surface portion represented by the chemical formula 2 may be prepared in the following manner:

A thickness of the core portion and a thickness of the surface portion range from 1% to 5% of a total size of a particle of the cathode active material for the lithium secondary battery,

a concentration of M1 is uniform from the core portion to the surface portion, and

concentrations of M2 and M3 have continuous concentration gradients from the core portion to the surface portion.

In an embodiment of the present invention, the chemical formula 1 or 2 may satisfy conditions of 0≦|x2−x1|≦0.4, 0.01≦|y2−y1|≦0.4, 0.1≦|z2−z1|≦0.5, 0.15≦x2≦0.35, 0.01≦y2≦0.3, and 0.5≦z2≦0.7.

At this time, in an embodiment of the present invention, the concentration of M3 may decrease from 0.90 molar ratio of the core portion to 0.65 molar ratio of the surface portion and the concentration of M2 may increase from 0.05 molar ratio of the core portion to 0.10 molar ratio of the surface portion. The concentration of M1 may increase from 0.05 molar ratio of the core portion to 0.25 molar ratio of the surface portion.

In another embodiment of the present invention, the concentration of M3 may be 0.75 molar ratio at the core portion but may decrease to 0.55 molar ratio at the surface portion. The concentration of M2 may increase from 0 molar ratio of the core portion to 0.20 molar ratio of the surface portion. The concentration of M1 may be uniformly 0.25 molar ratio at the core portion and the surface portion.

In an embodiment of the present invention, a particle size of the cathode active material for the lithium secondary battery is in a range of 0.1 μm to 1 μm, and more particularly, in a range of 0.1 μm to 0.6 μm. If the particle size of the cathode material is smaller than 0.1 μm, a tap density may be reduced. If the particle size of the cathode material is larger than 1.0 μm, the tap density may increase. However, since the particle size is too large, insertion and desorption distances of lithium ions are long in the structure to deteriorate electrochemical characteristics of a battery.

In an embodiment of the present invention, the cathode active material for the lithium secondary battery including the core portion represented by the chemical formula 1 and the surface portion represented by the chemical formula 2 may be prepared in the following manner: the M1 is Co, the M2 is Mn, and the M3 is Ni.

In an embodiment of the present invention, the cathode active material for the lithium secondary battery including the core portion represented by the chemical formula 1 and the surface portion represented by the chemical formula 2 may be prepared in the following manner: the M1 is Mn, the M2 is Co, and the M3 is Ni.

In an embodiment of the present invention, the cathode active material for the lithium secondary battery including the core portion represented by the chemical formula 1 and the surface portion represented by the chemical formula 2 may be prepared in the following manner: the M1 is Ni, the M2 is Co, and the M3 is Mn.

Embodiments of the present invention also provide a method for manufacturing a cathode active material for a lithium secondary battery. The method includes:

synthesizing a coating layer source material;

forming a cathode active material precursor for a lithium secondary battery;

mixing the coating layer source material and lithium salt with the cathode active material precursor for the lithium secondary battery to form a mixture; and

baking the mixture.

Embodiments of the present invention also provide a method for manufacturing a cathode active material for a lithium secondary battery. The method includes:

synthesizing a coating layer source material;

forming a cathode active material for a lithium secondary battery;

mixing the coating layer source material and the cathode active material with a solvent to form a mixture;

coating and drying the mixture; and

baking the coated and dried mixture.

In an embodiment of the manufacturing method of the present invention, the solvent may be selected from a group consisting of distilled water, methanol, ethanol, and any combination thereof.

In an embodiment of the manufacturing method of the present invention, the coating layer source material may be mixed at a ratio of 0.1 wt % to 1.00 wt % with respect to 100 wt % of the cathode active material.

If a mixing ratio of the coating layer source material is lower than 0.1 wt %, the effect by coating may not be shown. If a mixing ratio of an oxide of the coating element is higher than 1.00 wt %, the coating layer may be too thick to disturb insertion and desorption of lithium ions. Thus, conductivity may be deteriorated.

Embodiments of the present invention also provide a lithium secondary battery including a cathode active material on which at least one coating layer is formed.

### Advantageous Effects

The cathode active material of the present invention includes at least one coating layer which includes an oxide of a coating element and is formed on the surface of the cathode active material, and thus, the stability and electrical conductivity of the cathode active material are improved. In addition, the battery including cathode active material has excellent charge/discharge and cycle life characteristics and excellent thermal stability.

### BRIEF DESCRIPTION OF THE DRAWINGS

FIGS. 1, 5, and 10 show results of x-ray direction (XRD) measurement of cathode active materials manufactured in some embodiments of the present invention and some comparisons.

FIGS. 2, 6, 8, 11, 13, 15, 17, and 20 show charge/discharge characteristics of cells (batteries) using cathode active materials manufactured in some embodiments of the present invention and some comparisons.

FIGS. 3, 7, 9, 12, 14, 16, 18, and 21 show cycle life characteristics of cells (batteries) using cathode active materials manufactured in some embodiments of the present invention and some comparisons.

FIGS. 4 and 19 show results of differential scanning calorimetry (DSC) analysis of cathodes manufactured using cathode active materials manufactured in some embodiments of the present invention and some comparisons.

### BEST MODE FOR CARRYING OUT THE INVENTION

Hereinafter, exemplary embodiments of the present invention will be described in detail. However, it should be noted that the present invention is not limited to the following exemplary embodiments and may be implemented in various forms. Accordingly, the exemplary embodiments are provided only to disclose the present invention and let those skilled in the art know the category of the present invention.

### MANUFACTURE EXAMPLE

### Manufacture Example 1

### Manufacture of an Active Material Precursor Having a Core-Shell Structure

To manufacture a particle including a core having a constant concentration and a shell having a constant concentration, an aqueous metal salt solution (2.4 M concentration) for forming a core portion was prepared by mixing nickel sulfate, cobalt sulfate, and manganese sulfate with each other at a molar ratio of 90:5:5, and an aqueous metal salt solution for forming a surface portion was prepared by mixing nickel sulfate, cobalt sulfate, and manganese sulfate with each other at a molar ratio of 65:10:25. After 4 liter distilled water was provided into a co-precipitation reactor (having capacity of 4 L and including a rotary motor with an output power of 80 W), a nitrogen gas was supplied into the reactor at a rate of 0.5 liter/min to remove dissolved oxygen and the distilled water was stirred at a speed of 1000 rpm in the reactor maintained at a temperature of 50° C.

The aqueous metal salt solution for forming the core portion was provided into the reactor to form a core, and then, the aqueous metal salt solution for forming the surface portion was provided into the reactor at a rate of 0.3 liter/min to form an active material precursor including the core having the constant concentration and the shell having the constant concentration.

### Manufacture Example 2

### Manufacture of an Active Material Precursor Having a Core-Shell Structure Including a Shell Having a Concentration Gradient

An aqueous metal salt solution (2.4 M concentration) for forming a core portion was prepared by mixing nickel sulfate, cobalt sulfate, and manganese sulfate with each other at a molar ratio of 90:5:5, and an aqueous metal salt solution for forming a surface portion was prepared by mixing nickel sulfate, cobalt sulfate, and manganese sulfate with each other at a molar ratio of 55:15:30. The aqueous metal salt solution for forming the core portion was provided into the reactor to form a core, and then, the aqueous metal salt solution for forming the surface portion and the aqueous metal salt solution for forming the core portion were supplied at a rate of 0.3 liter/hour in the reactor while gradually changing a mixing ratio thereof. As a result, an active material precursor was manufactured to include the core having a constant concentration and a shell having a concentration gradient.

### Manufacture Example 3

### Manufacture of an Active Material Precursor Having a Gradient in Concentration of Metal Ions Throughout a Particle

To manufacture a compound in which Mn, Ni and Co have a concentration fixed from a center to a surface, a decreasing concentration and an increasing concentration, respectively, an aqueous metal salt solution (2.4 M concentration) for forming a core portion was prepared by mixing nickel sulfate and manganese sulfate with each other at a molar ratio of 75:25, and an aqueous metal salt solution for forming a surface portion was prepared by mixing nickel sulfate, cobalt sulfate, and manganese sulfate with each other at a molar ratio of 55:20:25. The same method as described in the manufacture example 2, except for these features of the present example, was performed to manufacture an active material precursor.

### Manufacture Example 4

### Manufacture of an Active Material Precursor Having Two Gradients in Metal Concentration

A shell having a concentration gradient and a certain thickness was formed using nickel sulfate, cobalt sulfate, and manganese sulfate mixed at a molar ratio of 98:00:02 as an aqueous metal salt solution for forming a core portion and using nickel sulfate, cobalt sulfate, and manganese sulfate mixed at a molar ratio of 85:05:10 as an aqueous metal salt solution for forming a surface portion, and then, a shell having a certain thickness was also formed using a solution obtained by mixing nickel sulfate, cobalt sulfate, and manganese sulfate mixed with each other at a molar ratio of 65:10:25. Thus, two gradients in concentration were formed in the shell. The same method as described in the manufacture example 1, except for these features of the present example, was performed to manufacture an active material precursor.

### Manufacture Example 5

### Manufacture of an Active Material Precursor Having a Core-Shell Structure

A solution obtained by mixing nickel sulfate, cobalt sulfate, and manganese sulfate at a molar ratio of 80:10:10 was used as an aqueous metal salt solution for forming a core portion, and a solution obtained by mixing nickel sulfate, cobalt sulfate, and manganese sulfate at a molar ratio of 50:20:30 was used as an aqueous metal salt solution for forming a surface portion. The same method as in the manufacture example 1, except for these features of the present example, was performed to manufacture an active material precursor.

### Manufacture Example 6

### Manufacture of an Active Material Precursor Having a Core-Shell Structure Including a Shell Having a Concentration Gradient

A solution obtained by mixing nickel sulfate, cobalt sulfate, and manganese sulfate at a molar ratio of 85:05:10 was used as an aqueous metal salt solution for forming a core portion, and a solution obtained by mixing nickel sulfate, cobalt sulfate, and manganese sulfate at a molar ratio of 60:15:25 was used as an aqueous metal salt solution for forming a surface portion. The same method as in the manufacture example 2, except for these features of the present example, was performed to manufacture an active material precursor.

### Manufacture Example 7

### Manufacture of an Active Material Precursor Having a Gradient in Concentration of Metal Ions Throughout a Particle

A solution obtained by mixing nickel sulfate, cobalt sulfate, and manganese sulfate at a molar ratio of 90:00:10 was used as an aqueous metal salt solution for forming a core portion, and a solution obtained by mixing nickel sulfate, cobalt sulfate, and manganese sulfate at a molar ratio of 54:15:31 was used as an aqueous metal salt solution for forming a surface portion. The same method as in the manufacture example 3, except for these features of the present example, was performed to manufacture an active material precursor.

### Manufacture Example 8

### Manufacture of an Active Material Precursor Having Two Gradients in Metal Concentration

A shell having a concentration gradient and a certain thickness was formed using nickel sulfate, cobalt sulfate, and manganese sulfate mixed at a molar ratio of 96:00:04 as an aqueous metal salt solution for forming a core portion and using nickel sulfate, cobalt sulfate, and manganese sulfate mixed at a molar ratio of 80:05:15 as an aqueous metal salt solution for forming a surface portion, and then, a shell having a certain thickness was also formed using a solution obtained by mixing nickel sulfate, cobalt sulfate, and manganese sulfate mixed with each other at a molar ratio of 55:15:30. Thus, two gradients in concentration were formed in the shell. The same method as described in the manufacture example 1, except for these features of the present example, was performed to manufacture an active material precursor.

### Manufacture Example 9

### Manufacture of an Active Material Precursor Having Two Gradients in Metal Concentration

A shell having a concentration gradient and a certain thickness was formed using nickel sulfate, cobalt sulfate, and manganese sulfate mixed at a molar ratio of 95:02:03 as an aqueous metal salt solution for forming a core portion and using nickel sulfate, cobalt sulfate, and manganese sulfate mixed at a molar ratio of 90:04:06 as an aqueous metal salt solution for forming a surface portion, and then, a shell having a certain thickness was also formed using a solution obtained by mixing nickel sulfate, cobalt sulfate, and manganese sulfate mixed with each other at a molar ratio of 67:09:24. Thus, two gradients in concentration were formed in the shell. The same method as described in the manufacture example 1, except for these features of the present example, was performed to manufacture an active material precursor.

### Embodiments 1 to 12

### Manufacture of a Cathode Active Material on which a PO4 Coating Layer is Formed

### Embodiments 1 to 4

(NH₄)₂HPO₄ was synthesized in a 4 liter continuous stirred-tank reactor (CSTR) under a condition of pH 5 and then was pulverized using a planetary mill to obtain nanometer-sized particles.

The obtained nano-particles of 0.25 wt % was mixed with LiNO₃ (as lithium salt) and the cathode active material precursor (99.75 wt %) of each of the manufacture examples 1 to 4. A dry ball milling coating process was performed on each of these mixtures at a speed of 100 rpm for 12 hours. At this time, a used container had a volume of 50 ml, and zirconia balls were used. The used zirconia balls had one ball of a diameter of 10 mm and three balls of a diameter of 5 mm. The cathode active materials coated with the nano-particles were thermally treated at 500° C. for 5 hours in an air atmosphere to manufacture cathode active materials coated with PO₄ of embodiments 1 to 4.

### Embodiments 5 to 8

Cathode active materials coated with PO₄ of embodiments 5 to 8 were manufactured by the same method as the embodiments 1 to 4 except for using NH₄PO₄ as a coating precursor and using the active material precursors of the manufacture examples 5 to 8.

### Embodiments 9 to 12

Cathode active materials coated with PO₄ of embodiments 9 to 12 were manufactured by the same method as the embodiments 1 to 4 except for using H₃PO₄ as a coating precursor and using the active material precursors of the manufacture examples 1, 6, 3 and 8.

### Comparison Example 1 to 9

Cathode active materials used as comparison examples 1 to 9 were manufactured by the same method as the embodiment 1 except for not using a coating precursor but using the active material precursors of the manufacture examples 1 to 9

### Experimental Example 1-1

### XRD Measurement

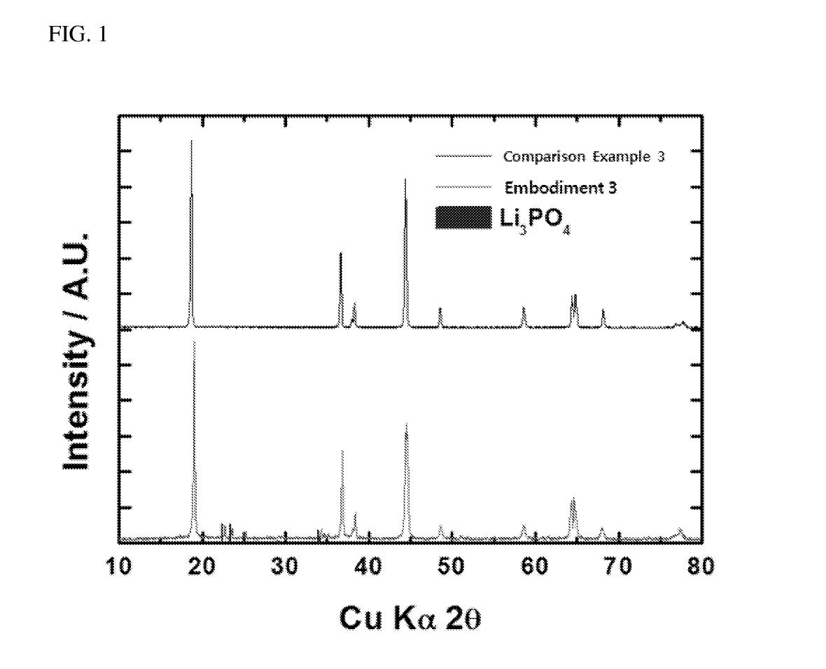

XRD measurement was performed to the cathode active materials manufactured in the embodiment 3 and the comparison example 3, and the results were shown in FIG. 1.

### Manufacture Example

### Manufacture of Coin Cell

The cathode active material of each of the embodiments 1 to 12 and the comparison examples 1 to 9, super P used as a conductive material, and polyvinylidene fluoride (PVdF) used as a binder were mixed with each other at a weight ratio of 85:7.5:7.5 to form slurry.

The slurry was uniformly coated on aluminum foil having a thickness of 20 μm, and then, the aluminum foil coated with the slurry was vacuum-dried at 120° C. to manufacture a cathode. A coin cell was manufactured using the manufactured cathode by a known method. At this time, lithium foil was used as an electrode opposite to the cathode, and a porous polyethylene layer (Celgard, LLC, No. Celgard 2300, a thickness: 25 μm) was used as a separator. In addition, the coin cell used a liquid electrolyte including a mixture solvent and 1.2M LiPF₆ dissolved in the mixture solvent. The mixture solvent was obtained by mixing ethylene carbonate and ethylmethyl carbonate with each other at a volume ratio of 3:7.

### Experimental Example 1-2

### Measurement of Charge/Discharge Capacity and Cycle Life Characteristic

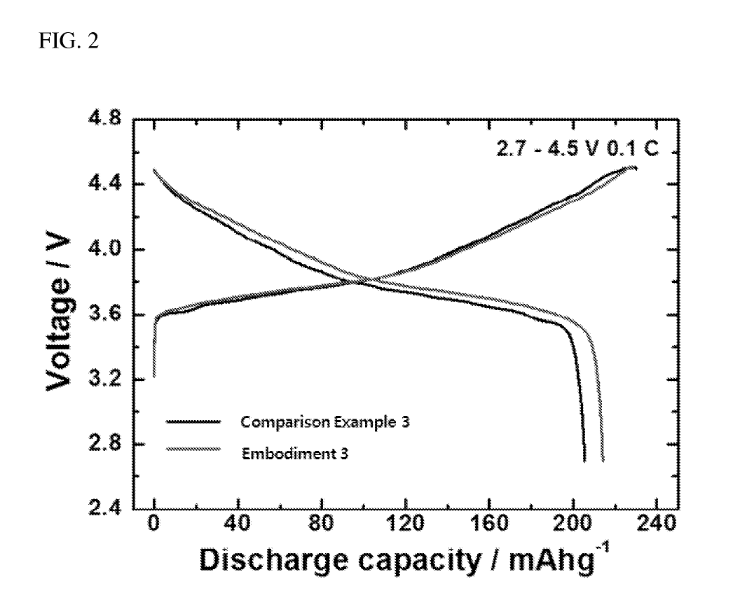

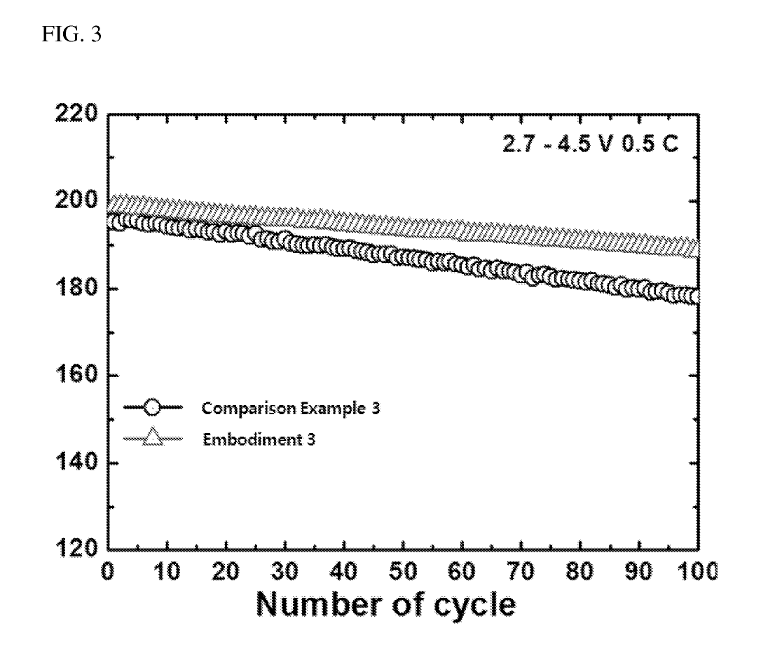

A charge/discharge test and a cycle life test were performed on the cells manufactured using the cathode active materials of the embodiments 1 to 12 and the comparison 1 to 8, and measured results were shown in FIGS. 2 and 3 and the following table 1.

The charge/discharge test was performed to each of the samples 10 times between 2.7V and 4.5V under a condition of 0.1 C, and an average value was taken from the measured values. The cycle life test was performed to each of the samples 60 times or more between 2.7V and 4.5V under conditions of 0.5 C and 25° C.

As shown in FIGS. 2 and 3 and the following table 1, the active materials of the embodiments including the PO₄ coating layers have excellent initial charge/discharge capacities and efficiency, compared with the active materials of the comparison examples not including the PO₄ coating layer. In addition, the active materials of the embodiments have excellent cycle life characteristic at 100 cycles.

TABLE 1

| | 0.1 C | 0.5 C Cycle | | 0.1 C | 0.5 C Cycle |
|---|---|---|---|---|---|
| | Discharge | life | | Discharge | life |
| Sample | capacity | characteristic | Sample | capacity | characteristic |
| (Precursor) | (mAh/g) | (100^{th} cycle) | (Precursor) | (mAh/g) | (100^{th} cycle) |
| Embodiment 1 | 203.2 | 91.7% | Comparison | 198.4 | 85.1% |
| (Manufacture | mAh/g | | example 1 | mAh/g | |
| example 1) | | | (Manufacture | | |
| | | | example 1) | | |
| Embodiment 2 | 208.9 | 92.9% | Comparison | 203.7 | 88.8% |
| (Manufacture | mAh/g | | example 2 | mAh/g | |
| example 2) | | | (Manufacture | | |
| | | | example 2) | | |
| Embodiment 3 | 214.2 | 94.8% | Comparison | 205.6 | 91.1% |
| (Manufacture | mAh/g | | example 3 | mAh/g | |
| example 3) | | | (Manufacture | | |
| | | | example 3) | | |
| Embodiment 4 | 221.1 | 93.1% | Comparison | 219.8 | 87.2% |
| (Manufacture | mAh/g | | example 4 | mAh/g | |
| example 4) | | | (Manufacture | | |
| | | | example 4) | | |
| Embodiment 5 | 207.9 | 89.1% | Comparison | 205.4 | 83.2% |
| (Manufacture | mAh/g | | example 5 | mAh/g | |
| example 5) | | | (Manufacture | | |
| | | | example 5) | | |
| Embodiment 6 | 213.7 | 92.8% | Comparison | 210.8 | 86.7% |
| (Manufacture | mAh/g | | example 6 | mAh/g | |
| example 6) | | | (Manufacture | | |
| | | | example 6) | | |
| Embodiment 7 | 216.7 | 94.3% | Comparison | 215.2 | 87.9% |
| (Manufacture | mAh/g | | example 7 | mAh/g | |
| example 7) | | | (Manufacture | | |
| | | | example 7) | | |
| Embodiment 8 | 213.4 | 96.3% | Comparison | 210.7 | 92.6% |
| (Manufacture | mAh/g | | example 8 | mAh/g | |
| example 8) | | | (Manufacture | | |
| | | | example 8) | | |
| Embodiment 9 | 201.7 | 92.8% | | | |
| (Manufacture | mAh/g | | | | |
| example 9) | | | | | |
| Embodiment 10 | 212.5 | 93.4% | | | |
| | mAh/g | | | | |
| Embodiment 11 | 207.2 | 96.9% | | | |
| | mAh/g | | | | |
| Embodiment 12 | 214.2 | 96.1% | | | |
| | mAh/g | | | | |

### Experimental Example 1-3

### Measurement of Thermal Stability by DSC

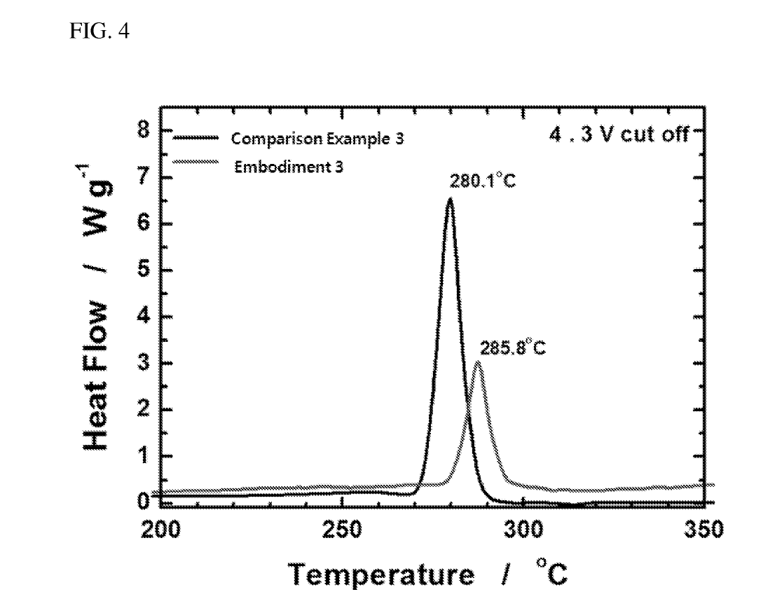

In a state that the cathode including each of the cathode active materials of the embodiments 1 to 12 and the comparison examples 1 to 8 was charged to 4.3V, the cathode was measured by a differential scanning calorimetry (DSC) analyzer while raising temperature at a rate of 10° C./min. The measured results were shown in FIG. 4 and the following table 2.

As shown in FIG. 4 and the following table 2, the active materials of the embodiments including the PO₄ coating layers have greatly improved thermal stability, compared with the active materials of the comparison examples not including the PO₄ coating layer.

TABLE 2

| Sample | DSC | | | DSC | |
|---|---|---|---|---|---|
| (Precursor) | Temperature | Calorie | Sample | Temperature | Calorie |
| Embodiment 1 | 273.9° C. | 417.5 J/g | Comparison | 270.1° C. | 827.1 J/g |
| (Manufacture | | | example 1 | | |
| example 1) | | | | | |
| Embodiment 2 | 277.1° C. | 363.8 J/g | Comparison | 271.9° C. | 793.6 J/g |
| (Manufacture | | | example 2 | | |
| example 2) | | | | | |
| Embodiment 3 | 285.8° C. | 269.1 J/g | Comparison | 280.1° C. | 724.2 J/g |
| (Manufacture | | | example 3 | | |
| example 3) | | | | | |
| Embodiment 4 | 270.2° C. | 402.7 J/g | Comparison | 265.7° C. | 811.4 J/g |
| (Manufacture | | | example 4 | | |
| example 4) | | | | | |
| Embodiment 5 | 266.7° C. | 432.5 J/g | Comparison | 263.1° C. | 896.5 J/g |
| (Manufacture | | | example 5 | | |
| example 5) | | | | | |
| Embodiment 6 | 278.1° C. | 387.4 J/g | Comparison | 273.8° C. | 791.8 J/g |
| (Manufacture | | | example 6 | | |
| example 6) | | | | | |
| Embodiment 7 | 258.1° C. | 453.6 J/g | Comparison | 250.7° C. | 973.7 J/g |
| (Manufacture | | | example 7 | | |
| example 7) | | | | | |
| Embodiment 8 | 279.3° C. | 327.8 J/g | Comparison | 276.1° C. | 772.4 J/g |
| (Manufacture | | | example 8 | | |
| example 8) | | | | | |
| Embodiment 9 | 273.4° C. | 417.5 J/g | | | |
| Embodiment 10 | 276.9° C. | 319.2 J/g | | | |
| Embodiment 11 | 283.5° C. | 315.7 J/g | | | |
| Embodiment 12 | 279.5° C. | 299.8 J/g | | | |

### Experimental Example 1-4

### Measurement of Residual Lithium

100 ml distilled water was mixed with the active material (10 g) of each of the embodiments 1 to 12 and the comparison 1 to 8, and then, the distilled water was filtered. The filtered distilled water of 50 ml was provided into a T50 apparatus of METLER TOLEDO international Inc., and a 10% aqueous hydrochloric acid solution was added little by little into the T50 apparatus to start titration. Two inflection points occurred after the titration. An added amount of the aqueous hydrochloric acid solution at the inflection point was measured to calculate the amount of residual lithium, and the results were shown in the following table 3.

TABLE 3

| Sample | Residual | | Residual |
|---|---|---|---|
| (Precursor) | lithium | Sample | lithium |
| Embodiment 1 | 5327 ppm | Comparison | 7832 ppm |
| (Manufacture | | example 1 | |
| example 1) | | | |
| Embodiment 2 | 4258 ppm | Comparison | 6325 ppm |
| (Manufacture | | example 2 | |
| example 2) | | | |
| Embodiment 3 | 4125 ppm | Comparison | 5897 ppm |
| (Manufacture | | example 3 | |
| example 3) | | | |
| Embodiment 4 | 6124 ppm | Comparison | 8972 ppm |
| (Manufacture | | example 4 | |
| example 4) | | | |
| Embodiment 5 | 6974 ppm | Comparison | 9765 ppm |
| (Manufacture | | example 5 | |
| example 5) | | | |
| Embodiment 6 | 5824 ppm | Comparison | 8265 ppm |
| (Manufacture | | example 6 | |
| example 6) | | | |
| Embodiment 7 | 5158 ppm | Comparison | 6538 ppm |
| (Manufacture | | example 7 | |
| example 7) | | | |
| Embodiment 8 | 4825 ppm | Comparison | 5614 ppm |
| (Manufacture | | example 8 | |
| example 8) | | | |
| Embodiment 9 | 5187 ppm | | |
| Embodiment 10 | 5987 ppm | | |
| Embodiment 11 | 4724 ppm | | |
| Embodiment 12 | 4698 ppm | | |

### Embodiments 13 to 16

### Manufacture of a Cathode Active Material on which a ZrO₂ Coating Layer is Formed

### Embodiments 13 to 16

### Formation of a ZrO₂ Coating Layer of 0.25 wt %

Zirconium acetatehydroxide ((CH₃CO₂)ₓZr(OH)_{y}, x+y=4), ZAH) was synthesized in a 4 L CSTR under a condition of pH 8 and then was pulverized using a planetary mill to obtain nanometer-sized particles.

The obtained nano-particles of 0.25 wt % was mixed with lithium salts (LiOH and Li₂CO₃) and the cathode active material precursor (99.75 wt %) of each of the manufacture examples 5, 2, 7, and 4. A dry ball milling coating process was performed on each of these mixtures at a speed of 100 rpm for 12 hours. At this time, a used container had a volume of 50 ml, and zirconia balls were used. The used zirconia balls had one ball of a diameter of 10 mm and three balls of a diameter of 5 mm. The cathode active materials coated with the nano-particles were thermally treated at 500° C. for 5 hours in an air atmosphere to manufacture cathode active materials coated with ZrO₂ of embodiments 13 to 16.

### Embodiment 15-2

### Formation of a ZrO₂ Coating Layer of 0.50 wt %

A cathode active material was manufactured by the same method as the embodiment 15 except for mixing the obtained nano-particles of 0.50 wt % with the cathode active material precursor (99.50 wt %) of the manufacture example 7.

### Embodiment 15-3

### Formation of a ZrO₂ Coating Layer of 0.75 wt %

A cathode active material was manufactured by the same method as the embodiment 15 except for mixing the obtained nano-particles of 0.75 wt % with the cathode active material precursor (99.25 wt %) of the manufacture example 7.

### Embodiment 15-4

### Formation of a ZrO₂ Coating Layer of 1.00 wt %

A cathode active material was manufactured by the same method as the embodiment 15 except for mixing the obtained nano-particles of 1.00 wt % with the cathode active material precursor (99.00 wt %) of the manufacture example 7.

### Experimental Example 2-1

### XRD Measurement

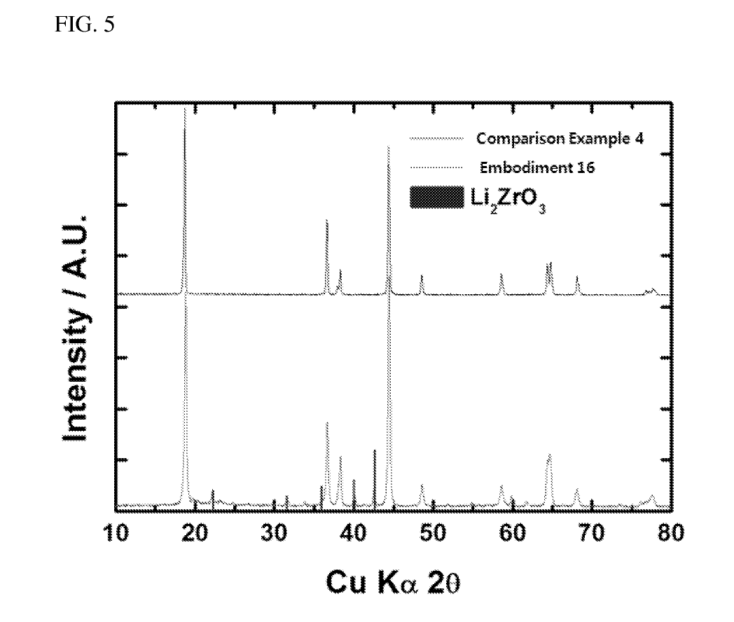

XRD measurement was performed to the cathode active materials manufactured in the embodiment 16 and the comparison example 4, and the results were shown in FIG. 5.

### Experimental Example 2-2

### Measurement of Cell Characteristics According to the Coating Amount of ZrO₂

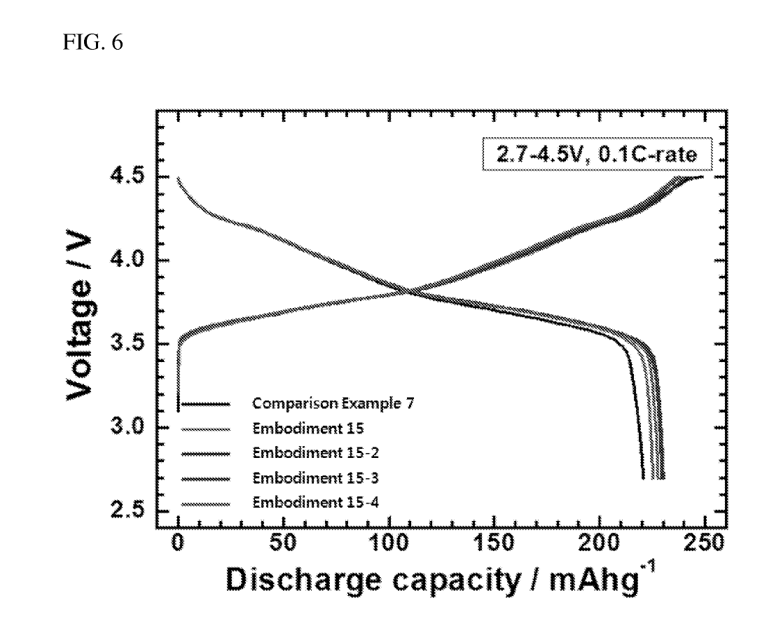

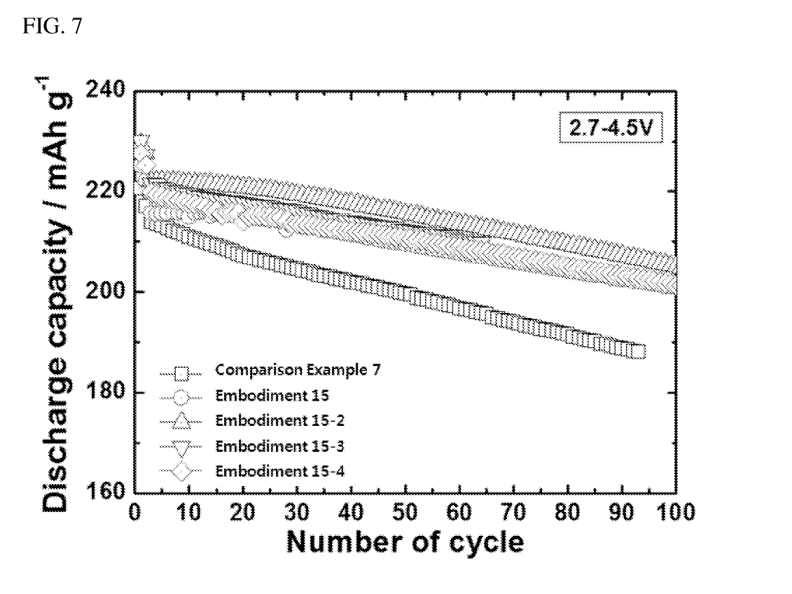

Cell characteristics of the embodiments 15 and 15-2 to 15-4 were measured, and the measured results were shown in FIGS. 6 and 7 and the following table 4.

TABLE 4

| | 0.1 C, 1st | | 0.2 C | 0.5 C | 0.5 C |
|---|---|---|---|---|---|
| | Discharge | 1st | Capacity | Capacity | Cycle |
| | capacity | Effi- | (mAh/g, | (mAh/g, | charac- |
| Sample | (25° C.) | ciency | 0.2 C/0.1 C) | 0.5 C/0.1 C) | teristic |
| Embodiment | 225.2 | 92.4% | 222.2 | 215.6 | 93.8% |
| 15 | mAh/g | | (98.7%) | (95.7%) | (91^{th}) |
| Embodiment | 229.5 | 94.2% | 227.7 | 222.1 | 93.0% |
| 15-2 | mAh/g | | (99.2%) | (96.8%) | (91^{th}) |
| Embodiment | 230.1 | 95.6% | 227.2 | 221.7 | 94.6% |
| 15-3 | mAh/g | | (98.7%) | (96.5%) | (62^{th}) |
| Embodiment | 227.7 | 95.2% | 225.3 | 219.9 | 92.3% |
| 15-4 | mAh/g | | (98.9%) | (96.6%) | (91^{th}) |
| Comparison | 220.6 | 88.7% | 217.0 | 213.8 | 87.9% |
| example 7 | mAh/g | | (98.3%) | (96.9%) | (91^{th}) |

### Experimental Example 2-3

### Measurement of Charge/Discharge Capacity and Cycle Life Characteristic

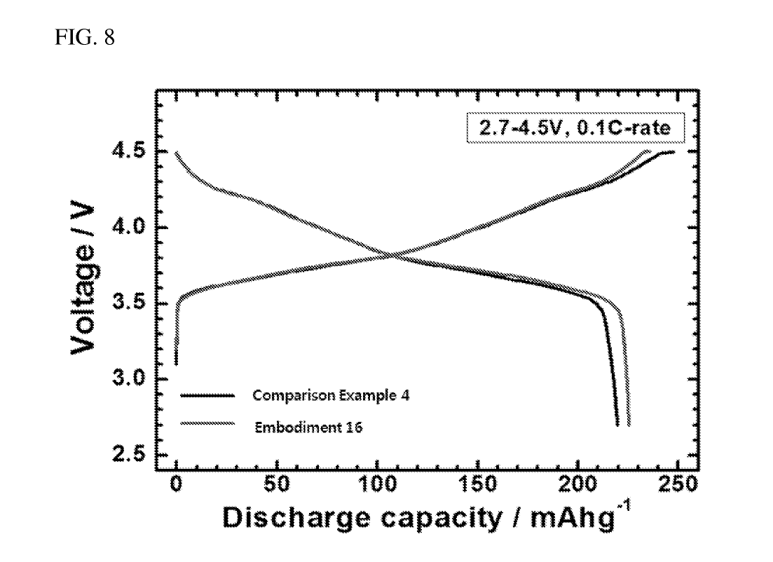

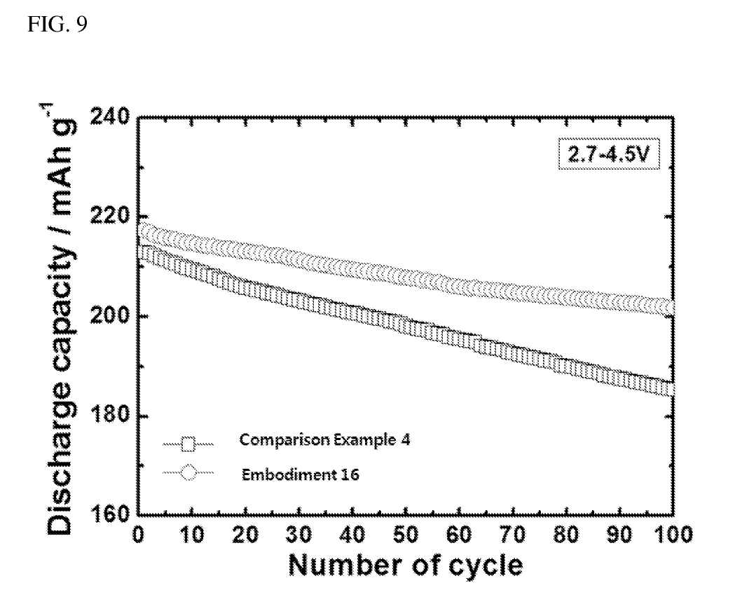

A charge/discharge test and a cycle life test were performed on a cell using each of the cathode active materials of the embodiments 13 to 16, and measured results were shown in FIGS. 8 and 9 and the following table 5.

TABLE 5

| | 0.1 C | 0.5 C Cycle | | 0.1 C | 0.5 C Cycle |
|---|---|---|---|---|---|
| | Discharge | life | | Discharge | life |
| Sample | capacity | characteristic | | capacity | characteristic |
| (Precursor) | (mAh/g) | (100^{th} cycle) | Sample | (mAh/g) | (100^{th} cycle) |
| Embodiment 13 | 206.9 | 88.1% | Comparison | 205.4 | 83.2% |
| (Manufacture | mAh/g | | example 5 | mAh/g | |
| example 5) | | | | | |
| Embodiment 14 | 207.6 | 93.4% | Comparison | 203.7 | 88.8% |
| (Manufacture | mAh/g | | example 2 | mAh/g | |
| example 2) | | | | | |
| Embodiment 15 | 217.8 | 94.6% | Comparison | 215.2 | 87.9% |
| (Manufacture | mAh/g | | example 7 | mAh/g | |
| example 7) | | | | | |
| Embodiment 16 | 225.5 | 92.9% | Comparison | 219.8 | 87.2% |
| (Manufacture | mAh/g | | example 4 | mAh/g | |
| example 4) | | | | | |

### Experimental Example 2-4

### Measurement of Residual Lithium

The residual lithium amounts of the cathode active materials of the embodiments 13 to 16 were calculated using the same method as the experimental example 1-4, and the results were shown in the following table 6.

TABLE 6

| Sample | Residual | | Residual |
|---|---|---|---|
| (Precursor) | lithium | Sample | lithium |
| Embodiment 13 | 7992 ppm | Comparison | 9765 ppm |
| (Manufacture | | example 5 | |
| example 5) | | | |
| Embodiment 14 | 5128 ppm | Comparison | 6325 ppm |
| (Manufacture | | example 2 | |
| example 2) | | | |
| Embodiment 15 | 4984 ppm | Comparison | 6538 ppm |
| (Manufacture | | example 7 | |
| example 7) | | | |
| Embodiment 16 | 7777 ppm | Comparison | 8972 ppm |
| (Manufacture | | example 4 | |
| example 4) | | | |

### Embodiments 17 and 18

### Manufacture of a Cathode Active Material on which a SeO₃ Coating Layer is Formed

Cathode active materials coated with SeO₃ of embodiments 17 and 18 were manufactured by the same method as the embodiment 1 except for using H₂SeO₃ as a coating precursor and using the active material precursors of the manufacture examples 6 and 9.

### Experimental example 3-1

### XRD Measurement

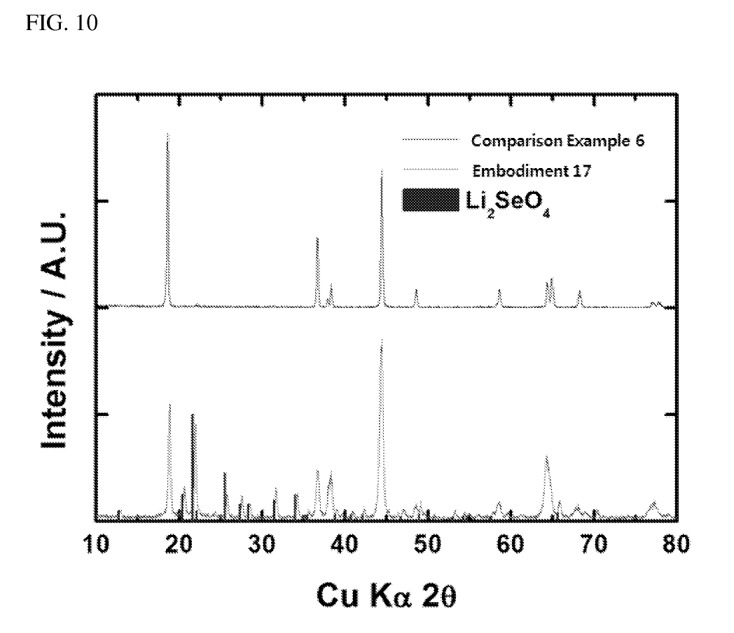

XRD measurement was performed to the cathode active materials manufactured in the embodiment 17 and the comparison example 6, and the results were shown in FIG. 10.

### Experimental example 3-2

### Measurement of Charge/Discharge Capacity and Cycle Life Characteristic

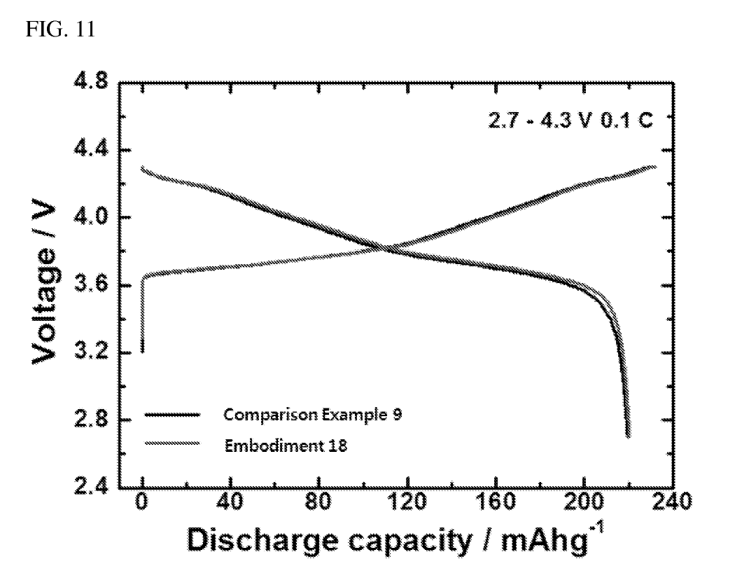

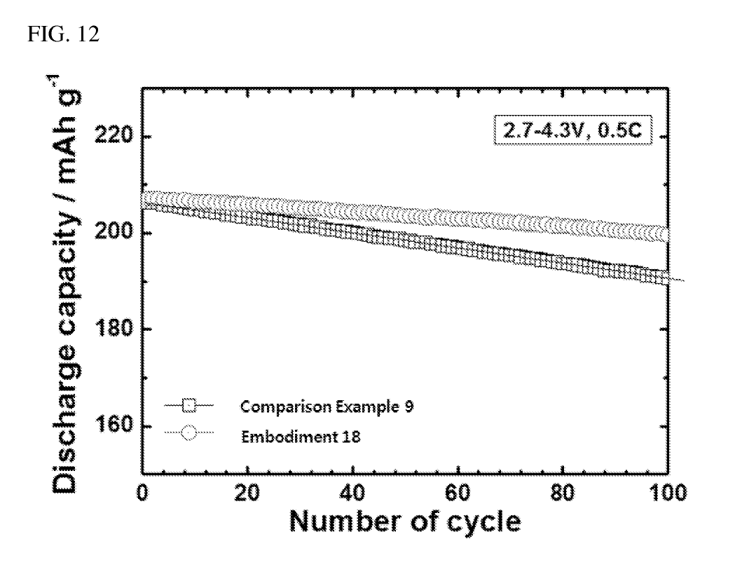

A charge/discharge test and a cycle life test were performed on a cell using each of the cathode active materials of the embodiments 17 and 18 and the comparison example 9, and measured results were shown in FIGS. 11 and 12 and the following table 7.

TABLE 7

| | 0.1 C | 0.5 C Cycle | | 0.1 C | 0.5 C Cycle |
|---|---|---|---|---|---|
| | Discharge | life | | Discharge | life |
| Sample | capacity | characteristic | | capacity | characteristic |
| (Precursor) | (mAh/g) | (100^{th} cycle) | Sample | (mAh/g) | (100^{th} cycle) |
| Embodiment 17 | 212.1 | 92.9% | Comparison | 202.7 | 89.2% |
| (Manufacture | mAh/g | | example 6 | mAh/g | |
| example 6) | | | | | |
| Embodiment 18 | 220.3 | 96.3% | Comparison | 219.5 | 92.3% |
| (Manufacture | mAh/g | | example 9 | mAh/g | |
| example 9) | | | | | |

### Experimental Example 3-3

### Measurement of Residual Lithium

The residual lithium amounts of the cathode active materials of the embodiments 17 and 18 and the comparison example 9 were calculated using the same method as the experimental example 1-4, and the results were shown in the following table 8.

TABLE 8

| Sample | Residual | | Residual |
|---|---|---|---|
| (Precursor) | lithium | Sample | lithium |
| Embodiment 17 | 6982 ppm | Comparison | 8265 ppm |
| (Manufacture | | example 6 | |
| example 6) | | | |
| Embodiment 18 | 5771 ppm | Comparison | 7835 ppm |
| (Manufacture | | example 9 | |
| example 9) | | | |

### Embodiments 19 and 20

### Manufacture of a Cathode Active Material on which a SnO₂ Coating Layer is Formed

Cathode active materials coated with SnO₂ of embodiments 19 and 20 were manufactured by the same method as the embodiment 1 except for using H₂SnO₃ as a coating precursor and using the active material precursors of the manufacture examples 7 and 9.

### Experimental Example 4-1

### Measurement of Charge/Discharge Capacity and Cycle Life Characteristic

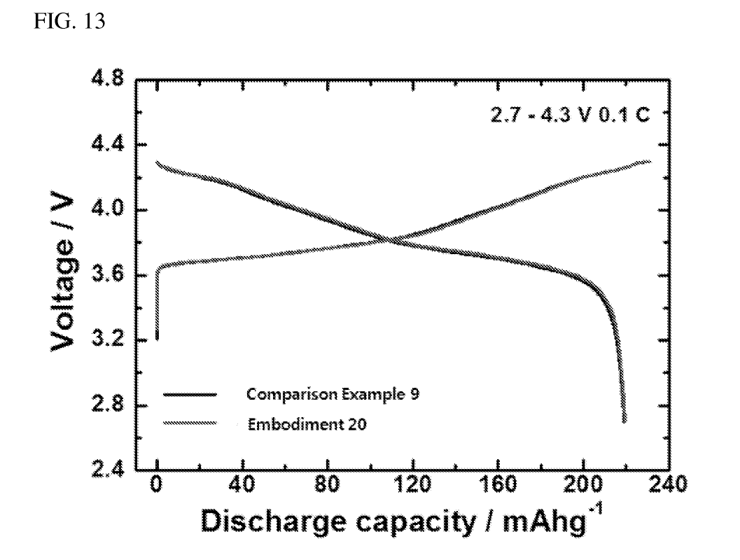

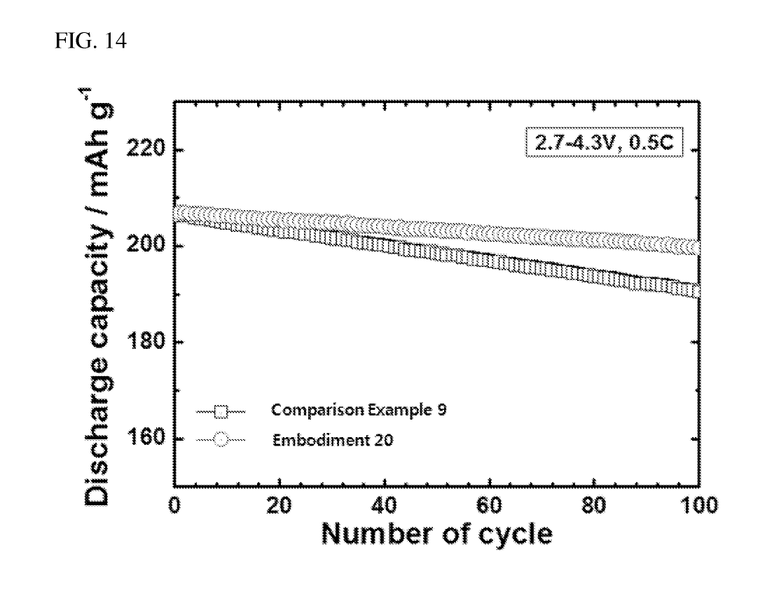

A charge/discharge test and a cycle life test were performed on a cell using each of the cathode active materials of the embodiments 19 and 20, and measured results were shown in FIGS. 13 and 14 and the following table 9.

TABLE 9

| | 0.1 C | 0.5 C Cycle | | 0.1 C | 0.5 C Cycle |
|---|---|---|---|---|---|
| | Discharge | life | | Discharge | life |
| Sample | capacity | characteristic | | capacity | characteristic |
| (Precursor) | (mAh/g) | (100^{th} cycle) | Sample | (mAh/g) | (100^{th} cycle) |
| Embodiment 19 | 207.2 | 92.8% | Comparison | 206.7 | 89.9% |
| (Manufacture | mAh/g | | example 7 | mAh/g | |
| example 7) | | | | | |
| Embodiment 20 | 220.3 | 96.2% | Comparison | 219.5 | 92.3% |
| (Manufacture | mAh/g | | example 9 | mAh/g | |
| example 9) | | | | | |

### Experimental Example 4-2

### Measurement of Residual Lithium

The residual lithium amounts of the cathode active materials of the embodiments 19 and 20 and the comparison examples 6 and 9 were calculated using the same method as the experimental example 1-4, and the results were shown in the following table 10.

TABLE 10

| Sample | Residual | | Residual |
|---|---|---|---|
| (Precursor) | lithium | Sample | lithium |
| Embodiment 19 | 4825 ppm | Comparison | 6538 ppm |
| (Manufacture | | example 6 | |
| example 7) | | | |
| Embodiment 20 | 5813 ppm | Comparison | 7835 ppm |
| (Manufacture | | example 9 | |
| example 9) | | | |

### Embodiments 21 to 26

### Manufacture of a Cathode Active Material on which a PO₄ Coating Layer is Formed

### Embodiments 21 and 22

(NH₄)₂HPO₄ was synthesized in a 4 L CSTR under a condition of pH 5 and then was pulverized using a planetary mill to obtain nanometer-sized particles.

Each of the active material precursors of the manufacture examples 1 and 3 and lithium hydroxide (LiOH) were mixed with each other at a molar ratio of 1.0:1.19, and then, a preliminary baking process was performed on the mixture. In the preliminary baking process, the mixture was heated at a heating rate of 2° C./min and was maintained at a temperature of 280° C. for 5 hours. Thereafter, the mixture was baked at a temperature of 900° C. for 10 hours to manufacture a cathode active material.

The obtained nano-particles of 0.25 wt % was mixed with the manufactured cathode active material of 99.75 wt % in a solvent (distilled water, methanol, or ethanol), and a wet coating process was performed at a speed 100 rpm for 12 hours. The cathode active materials coated with the nano-particles were thermally treated at 500° C. for 5 hours in an air atmosphere to manufacture cathode active materials coated with PO₄ of embodiments 21 and 22.

### Embodiments 23 and 24

Cathode active materials coated with PO₄ of embodiments 23 and 24 were manufactured by the same method as the embodiment 21 except for using NH₄PO₄ as a coating precursor and using the active material precursors of the manufacture examples 6 and 9.

### Embodiments 25 and 261

Cathode active materials coated with PO₄ of embodiments 25 and 26 were manufactured by the same method as the embodiment 21 except for using H₃PO₄ as a coating precursor and using the active material precursors of the manufacture examples 7 and 9.

### Experimental example 5-1

### Measurement of Charge/Discharge Capacity and Cycle Life Characteristic

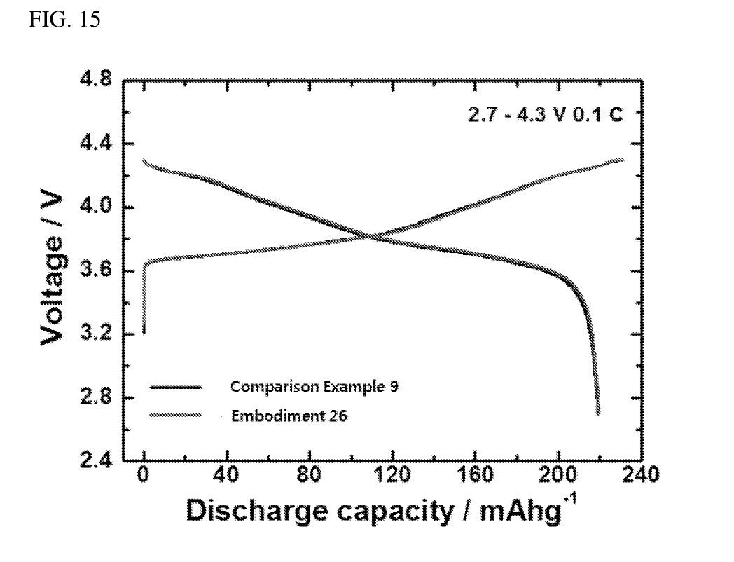

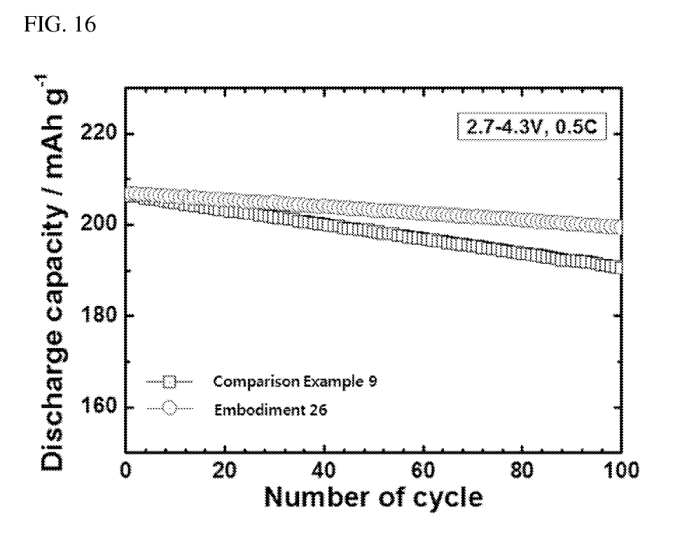

A charge/discharge test and a cycle life test were performed on a cell using each of the cathode active materials of the embodiments 21 to 26, and measured results were shown in FIGS. 15 and 16 and the following table 11.

TABLE 11

| | 0.1 C | 0.5 C Cycle | | 0.1 C | 0.5 C Cycle |
|---|---|---|---|---|---|
| | Discharge | life | | Discharge | life |
| Sample | capacity | characteristic | | capacity | characteristic |
| (Precursor) | (mAh/g) | (100^{th} cycle) | Sample | (mAh/g) | (100^{th} cycle) |
| Embodiment 21 | 202.9 | 91.9% | Comparison | 198.4 | 85.1% |
| (Manufacture | mAh/g | | example 1 | mAh/g | |
| example 1) | | | | | |
| Embodiment 22 | 209.2 | 94.9% | Comparison | 205.6 | 91.1% |
| (Manufacture | mAh/g | | example 3 | mAh/g | |
| example 3) | | | | | |
| Embodiment 23 | 213.5 | 93.0% | Comparison | 210.8 | 86.7% |
| (Manufacture | mAh/g | | example 6 | mAh/g | |
| example 6) | | | | | |
| Embodiment 24 | 220.1 | 96.2% | Comparison | 215.2 | 87.9% |
| (Manufacture | mAh/g | | example 7 | mAh/g | |
| example 9) | | | | | |
| Embodiment 25 | 217.7 | 94.7% | Comparison | 219.5 | 92.3% |
| (Manufacture | mAh/g | | example 9 | mAh/g | |
| example 7) | | | | | |
| Embodiment 26 | 220.2 | 96.3% | | | |
| (Manufacture | mAh/g | | | | |
| example 9) | | | | | |

### Experimental Example 5-2

### Measurement of Residual Lithium

The residual lithium amounts of the cathode active materials of the embodiments 21 to 26 were calculated using the same method as the experimental example 1-4, and the results were shown in the following table 12.

TABLE 12

| Sample | Residual | | Residual |
|---|---|---|---|
| (Precursor) | lithium | Sample | lithium |
| Embodiment 21 | 5748 ppm | Comparison | 7832 ppm |
| (Manufacture | | example 1 | |
| example 1) | | | |
| Embodiment 22 | 4426 ppm | Comparison | 5897 ppm |
| (Manufacture | | example 3 | |
| example 3) | | | |
| Embodiment 23 | 6021 ppm | Comparison | 8265 ppm |
| (Manufacture | | example 6 | |
| example 6) | | | |
| Embodiment 24 | 5921 ppm | Comparison | 6538 ppm |
| (Manufacture | | example 7 | |
| example 9) | | | |
| Embodiment 25 | 4921 ppm | Comparison | 7835 ppm |
| (Manufacture | | example 9 | |
| example 7) | | | |
| Embodiment 26 | 5798 ppm | | |
| (Manufacture | | | |
| example 9) | | | |

### Embodiments 27 and 28

### Manufacture of a Cathode Active Material on which a SeO₃ Coating Layer is Formed

Cathode active materials coated with SeO₃ of embodiments 27 and 28 were manufactured by the same method as the embodiment 21 except for using H₂SeO₃ as a coating precursor and using the active material precursors of the manufacture examples 1 and 9.

### Experimental Example 6-1

### Measurement of Charge/Discharge Capacity and Cycle Life Characteristic

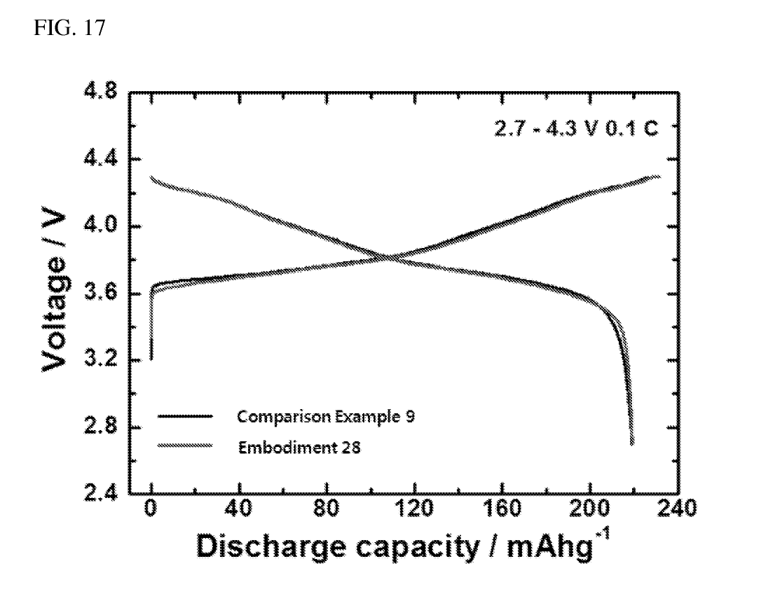

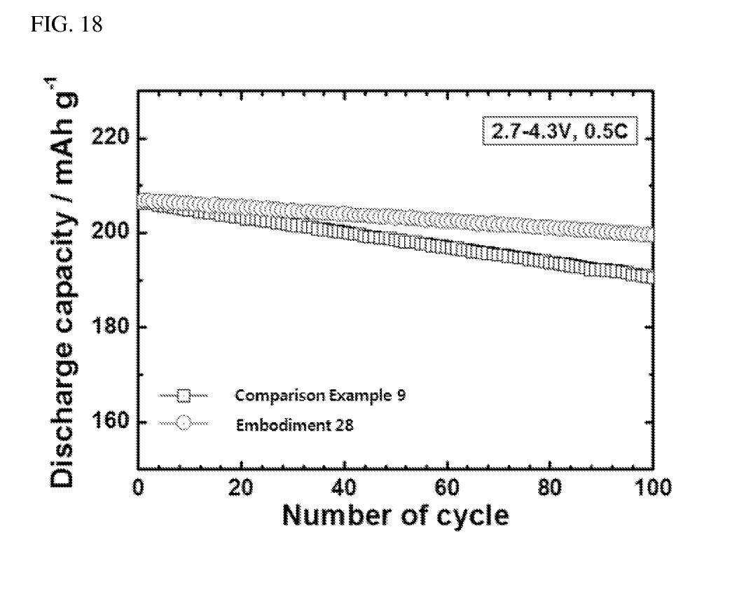

A charge/discharge test and a cycle life test were performed on a cell using each of the cathode active materials of the embodiments 27 and 28, and measured results were shown in FIGS. 17 and 18 and the following table 13.

TABLE 13

| | 0.1 C | 0.5 C Cycle | | 0.1 C | 0.5 C Cycle |
|---|---|---|---|---|---|
| | Discharge | life | | Discharge | life |
| Sample | capacity | characteristic | | capacity | characteristic |
| (Precursor) | (mAh/g) | (100^{th} cycle) | Sample | (mAh/g) | (100^{th} cycle) |
| Embodiment 27 | 204.0 | 91.5% | Comparison | 198.4 | 85.1% |
| (Manufacture | mAh/g | | example 1 | mAh/g | |
| example 1) | | | | | |
| Embodiment 28 | 219.8 | 96.4% | Comparison | 219.5 | 92.3% |
| (Manufacture | mAh/g | | example 9 | mAh/g | |
| example 9) | | | | | |

### Experimental Example 6-2

### Measurement of Thermal Stability by DSC

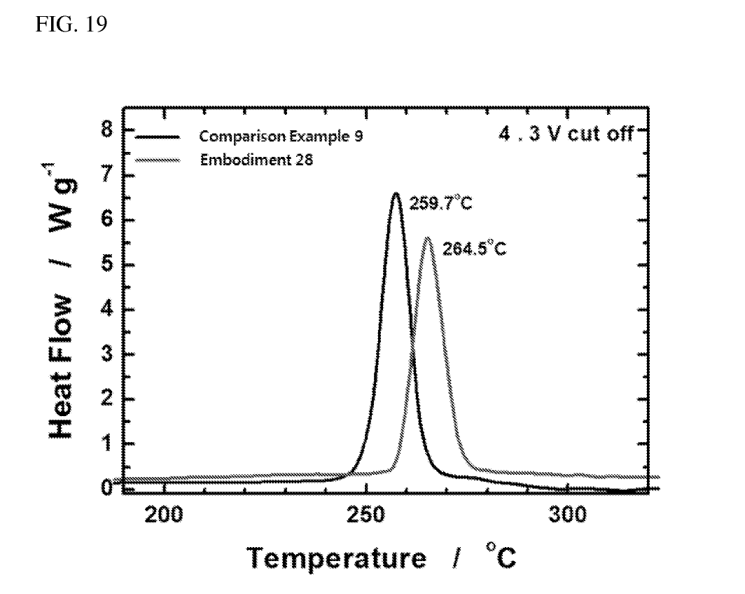

In a state that the cathode including each of the cathode active materials of the embodiments 27 and 28 and the comparison example 9 was charged to 4.3V, the cathode was measured by a DSC analyzer while raising temperature at a rate of 10° C./min. The measured results were shown in FIG. 19 and the following table 14.

TABLE 14

| Sample | DSC | | Sample | DSC | |
|---|---|---|---|---|---|
| (Precursor) | Temperature | Calorie | (Precursor) | Temperature | Calorie |
| Embodiment 27 | 289.6° C. | 315.1 J/g | Comparison | 284.3° C. | 503.5 J/g |
| (Manufacture | | | example 1 | | |
| example 1) | | | | | |
| Embodiment 28 | 264.5° C. | 709.0 J/g | Comparison | 259.7° C. | 797.5 J/g |
| (Manufacture | | | example 9 | | |
| example 9) | | | | | |

### Experimental Example 6-3

### Measurement of Residual Lithium

The residual lithium amounts of the cathode active materials of the embodiments 27 and 28 were calculated using the same method as the experimental example 1-4, and the results were shown in the following table 15.

TABLE 15

| Sample | Residual | | Residual |
|---|---|---|---|
| (Precursor) | lithium | Sample | lithium |
| Embodiment 27 | 5919 ppm | Comparison | 7832 ppm |
| (Manufacture | | example 1 | |
| example 1) | | | |
| Embodiment 28 | 5517 ppm | Comparison | 7835 ppm |
| (Manufacture | | example 9 | |
| example 9) | | | |

### Embodiments 29 and 30

### Manufacture of a Cathode Active Material on which a SnO₂ Coating Layer is Formed

Cathode active materials coated with SnO₂ of embodiments 29 and 30 were manufactured by the same method as the embodiment 21 except for using H₂SnO₃ as a coating precursor and using the active material precursors of the manufacture examples 6 and 3.

### Experimental Example 7-1

### Measurement of Charge/Discharge Capacity and Cycle Life Characteristic

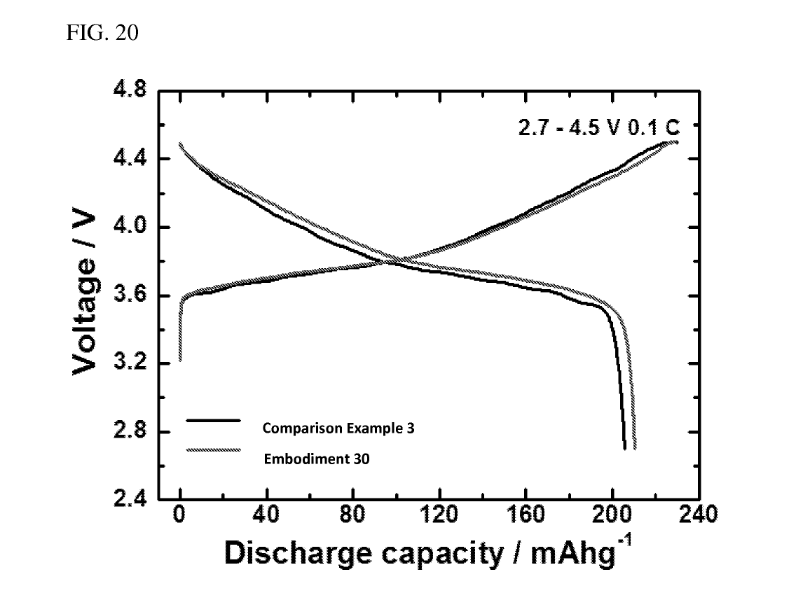

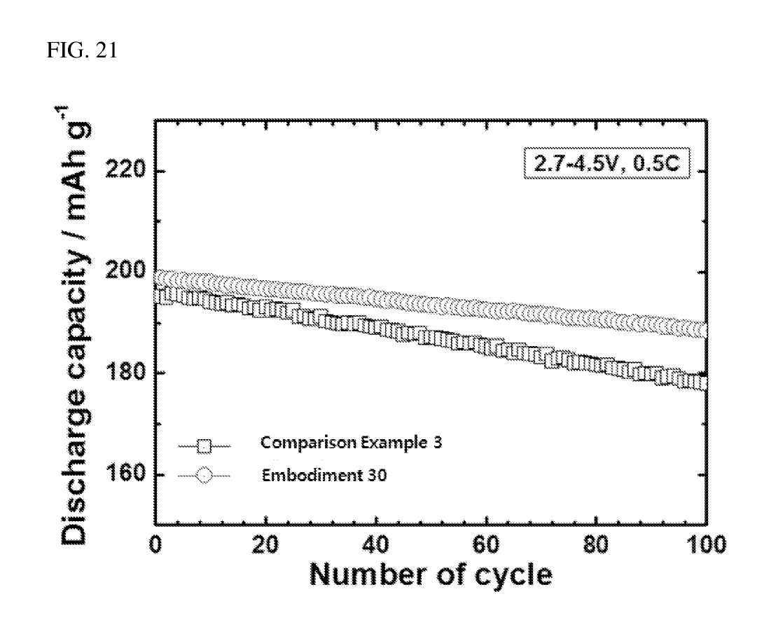

A charge/discharge test and a cycle life test were performed on a cell using each of the cathode active materials of the embodiments 29 and 30, and measured results were shown in FIGS. 20 and 21 and the following table 16.

TABLE 16

| | 0.1 C | 0.5 C Cycle | | 0.1 C | 0.5 C Cycle |
|---|---|---|---|---|---|
| | Discharge | life | | Discharge | life |
| Sample | capacity | characteristic | | capacity | characteristic |
| (Precursor) | (mAh/g) | (100^{th} cycle) | Sample | (mAh/g) | (100^{th} cycle) |
| Embodiment 29 | 214.1 | 92.5% | Comparison | 210.8 | 86.7% |
| (Manufacture | mAh/g | | example 6 | mAh/g | |
| example 6) | | | | | |
| Embodiment 30 | 210.3 | 94.5% | Comparison | 205.6 | 91.1% |
| (Manufacture | mAh/g | | example 3 | mAh/g | |
| example 3) | | | | | |

### Experimental Example 7-2

### Measurement of Residual Lithium

The residual lithium amounts of the cathode active materials of the embodiments 29 and 30 were calculated using the same method as the experimental example 1-4, and the results were shown in the following table 17.

TABLE 17

| Sample | Residual | | Residual |
|---|---|---|---|
| (Precursor) | lithium | Sample | lithium |
| Embodiment 29 | 6127 ppm | Comparison | 8265 ppm |
| (Manufacture | | example 6 | |
| example 6) | | | |
| Embodiment 30 | 4687 ppm | Comparison | 5897 ppm |
| (Manufacture | | example 3 | |
| example 3) | | | |

### INDUSTRIAL APPLICABILITY

The cathode active material of the present invention includes at least one coating layer which includes an oxide of a coating element and is formed on the surface of the cathode active material, and thus, the stability and electrical conductivity of the cathode active material are improved. In addition, the battery including cathode active material has excellent charge/discharge and cycle life characteristics and excellent thermal stability.

What is claimed is:

1. A cathode active material for a lithium secondary battery,
wherein at least one coating layer is formed on a surface of the cathode active material, the cathode active material comprising:
a core portion represented by the following chemical formula 1; and
a surface portion represented by the following chemical formula 2,
Liₐ₁M1ₓ₁M2_{y1}M3_{z1}M4_{w}O_{2+δ}, [chemical formula 1]
Liₐ₂M1ₓ₂M2_{y2}M3_{z2}M4_{w}O_{2+δ}, [chemical formula 2]
where, in the chemical formulas 1 and 2, “M1”, “M2”, and “M3” are selected from the group consisting of Ni, Co, Mn, and any combination thereof, “M4” is selected from the group consisting of Fe, Na, Mg, Ca, Ti, V, Cr, Cu, Zn, Ge, Sr, Ag, Ba, Zr, Nb, Mo, Al, Ga, B, and any combination thereof, 0≦a1≦1.1, 0≦a2≦1.1, 0≦x1≦1, 0≦x2≦1, 0≦y1≦1, 0≦y2≦1, 0≦z1≦1, 0≦z2≦1, 0≦w≦0.1, 0.0≦δ≦0 0.5, 0<x1+y1+z1≦1, 0<x2+y2+z2≦1, y1≦y2, and z2≦z1.

2. The cathode active material of claim 1, wherein the coating layer includes at least one element selected from a group consisting of P, Zr, Sc, Y, Li, Na, K, Rb, Mg, Ca, Sr, Ba, La, Ti, V, Nb, Cr, Mo, W, Mn, Re, Fe, Ru, Os, Co, Rh, Ir, Ni, Pd, Pt, Cu, Ag, Au, Zn, B, Al, Ga, In, Si, Ge, Sn, Pb, As, Sb, Bi, Se, Te, and any combination thereof.

3. The cathode active material of claim 1, wherein the coating layer is represented by the following chemical formula 3,
DₚJ_{q}Oᵣ [chemical formula 3]
where, in the chemical formula 3, “D” is selected from a group consisting of P, Zr, Sc, Y, Li, Na, K, Rb, Mg, Ca, Sr, Ba, La, Ti, V, Nb, Cr, Mo, W, Mn, Re, Fe, Ru, Os, Co, Rh, Ir, Ni, Pd, Pt, Cu, Ag, Au, Zn, B, Al, Ga, In, Si, Ge, Sn, Pb, As, Sb, Bi, Se, Te, and any combination thereof, “J” is selected from a group consisting of Li, Na, K, Rb, Mg, Ca, Sr, Ba, Y, La, Ti, Zr, V, Nb, Cr, Mo, W, Mn, Re, Fe, Ru, Os, Co, Rh, Ir, Ni, Pd, Pt, Cu, Ag, Au, Zn, B, Al, Ga, In, Si, Ge, Sn, Pb, As, Sb, Bi, Se, Te, and any combination thereof, 0<p≦4, 0≦q≦1, and 0≦r≦10.

4. The cathode active material of claim 3, wherein the coating layer includes one selected from a group consisting of ZrO₂, PO₄, SeO₃, and SnO₂.

5. The cathode active material of claim 1, wherein a thickness of the coating layer is in a range of 1 nm to 150 nm.

6. The cathode active material of claim 1, wherein a thickness of the core portion is in a range of 10% to 70% of a total size of a particle of the cathode active material for the lithium secondary battery, and
wherein a concentration of metal ions from the core portion to the surface portion is uniformly represented by the chemical formula 2.

7. The cathode active material of claim 1, wherein a thickness of the core portion is in a range of 10% to 70% of a total size of a particle of the cathode active material for the lithium secondary battery,
wherein a thickness of the surface portion is in a range of 1% to 5% of the total size of the particle of the cathode active material for the lithium secondary battery, and
wherein concentrations of M1, M2, and M3 have continuous concentration gradients from the core portion to the surface portion.

8. The cathode active material of claim 1, wherein a thickness of the core portion and a thickness of the surface portion range from 1% to 5% of a total size of a particle of the cathode active material for the lithium secondary battery, and
wherein concentrations of M1, M2, and M3 have continuous concentration gradients from the core portion to the surface portion.

9. The cathode active material of claim 8, wherein the concentrations of M1 and M2 have continuously increasing concentration gradients from the core portion to the surface portion, and
wherein the concentration of M3 has continuously decreasing concentration gradient from the core portion to the surface portion.

10. The cathode active material of claim 1, wherein a thickness of the core portion and a thickness of the surface portion range from 1% to 5% of a total size of a particle of the cathode active material for the lithium secondary battery,
wherein a concentration of M1 is uniform from the core portion to the surface portion, and
wherein concentrations of M2 and M3 have continuous concentration gradients from the core portion to the surface portion.

11. The cathode active material of claim 1, wherein the chemical formula 1 or 2 satisfies conditions of 0≦|x2−x1|≦0.4, 0.01≦|y2−y1|≦0.4, 0.1≦|z2−z1|≦0.5, 0.15≦x2≦0.35, 0.01≦y2≦0.3, and 0.5≦z2≦0.7.

12. The cathode active material of claim 1, wherein a particle size of the cathode active material for the lithium secondary battery is in a range of 0.1 μm to 1 μm.

13. The cathode active material of claim 1, wherein the M1 is Co, the M2 is Mn, and the M3 is Ni.

14. The cathode active material of claim 1, wherein the M1 is Mn, the M2 is Co, and the M3 is Ni.

15. The cathode active material of claim 1, wherein the M1 is Ni, the M2 is Co, and the M3 is Mn.

16. A method for manufacturing the cathode active material for the lithium secondary battery of claim 1, the method comprising:
synthesizing a coating layer source material;
forming a cathode active material precursor for a lithium secondary battery;
mixing the coating layer source material and lithium salt with the cathode active material precursor for the lithium secondary battery to form a mixture; and
baking the mixture.

17. A method for manufacturing the cathode active material for the lithium secondary battery of claim 1, the method comprising:
synthesizing a coating layer source material;
forming a cathode active material for a lithium secondary battery;
mixing the coating layer source material and the cathode active material with a solvent to form a mixture;
coating and drying the mixture; and
baking the coated and dried mixture.

18. The method of claim 17 or 18, wherein the coating layer source material is mixed at a ratio of 0.1 wt % to 1.00 wt % with respect to 100 wt % of the cathode active material.

19. The method of claim 18, wherein the solvent is selected from a group consisting of distilled water, methanol, ethanol, and any combination thereof.

20. A lithium secondary battery comprising the cathode active material of claim 1.
